(19) United States
(12) Patent Application Publication
(10) Pub. No.: US 2025/0178406 A1
(43) Pub. Date: Jun. 5, 2025

(54) CONDITIONING SYSTEM FOR THERMAL EFFECTORS

(71) Applicant: GENTHERM INCORPORATED, Northville, MI (US)

(72) Inventors: Jeremy Swanson, Ypsilanti, MI (US); Tyler Myers, Plymouth, MI (US); Chad Westerman, Milford, MI (US); Satya Naren Karthik Mandali, Farmington Hills, MI (US); Ankit Tiwari, Farmington Hills, MI (US)

(21) Appl. No.: 18/862,067

(22) PCT Filed: May 31, 2023
(86) PCT No.: PCT/US2023/023922

§ 371 Date: Oct. 31, 2024

Related U.S. Application Data
(60) Provisional application No. 63/352,751, filed on Jun. 16, 2022.

(51) Int. Cl. B60H 1/00; B60H 1/22

(52) U.S. Cl. CPC B60H 1/00807; B60H 1/00478; B60H 1/0073; B60H 1/00828; B60H 1/2218; B60H 1/2227; B60H 2001/00733

(57) ABSTRACT

A conditioning system operable in a vehicle. The conditioning system comprises a thermal effector, a first local sensor associated with the thermal effector, and a controller in signaling communication with the thermal effector and the first local sensor. The controller or an additional controller dynamically estimates a thermal condition remote from and at least partially influenced by the thermal effector. The dynamic estimation is based on a first temperature sensed by the first local sensor and optionally a second temperature sensed by an optional second local sensor. The controller controls the thermal effector based on the dynamically estimated thermal condition.

### CROSS-REFERENCE TO RELATED APPLICATIONS

The present application is a national phase of International Application No. PCT/US2023/023922 filed May 31, 2023, which claims priority to U.S. Provisional Application No. 63/352,751, filed on Jun. 16, 2022, and incorporated herein by reference in its entirety for all purposes.

### FIELD

The present disclosure relates to a conditioning system operable in a vehicle. The conditioning system comprises one or more controllers for controlling one or more thermal effectors that regulate a surface temperature and/or an airstream temperature.

### BACKGROUND

Some climatized vehicle systems operate under a set of predetermined discrete setpoints, which are selected by occupants with the actuation of buttons, dials, and the like. One drawback to these systems is the inability to regulate temperature between the setpoints. Another drawback is the continuous changing of the temperature setpoints during operation of the vehicle.

To address these challenges, some climatized vehicle systems employ sensors that monitor parameters such as the temperature of thermal effectors, blower speed, outside temperature, sun radiation, cabin air temperature, humidity, and the number of occupants. The setpoint selected by the occupant is then correlated, via lookup tables, to these parameters and thus the operation of thermal effectors (e.g., the duty cycle of a heater mat) is directed by both the setpoint and parameters. These systems operate under a finite number of pre-determined scenarios. One drawback to these systems is the large degree of calibration effort undertaken to account for the possible scenarios the vehicle may be exposed to. By way of example, systems are typically calibrated to account for driving in different seasons, geographical climates, weather conditions, and the like. Moreover, the calibrations are performed for each make, model, model year, and trim level of vehicle due to the different effects such parameters have on different vehicle builds, including the quantity and location of thermal effectors.

Typically, sensors and thermal effectors are calibrated individually. Thus, calibrations are undertaken for individual effectors. Due to this individual treatment, thermal effectors typically do not communicate with one another to cooperate in conditioning the vehicle or energy usage. Thus, where a surface is conditioned by multiple thermal effectors, ramp-up to the setpoint temperature typically proceeds slowly in an abundance of caution not to cause discomfort to the occupant.

Similarly, as the calibration accounts for cabin air temperature rather than surface temperature, the operation of thermal effectors is undertaken cautiously to avoid overheating or overcooling occupants, which may cause discomfort. Thus, the time it takes for surfaces to arrive at the selected setpoint temperature is longer relative to other methods.

Some climatized vehicle systems calibrate thermal effectors to specific cabin air temperatures. However, cabin air temperature does not accurately characterize the temperature felt at surfaces by occupants and is subject to constant fluctuations. While providing a sensor proximate to a surface may detect the temperature felt at that surface, several challenges are realized. Repeatable accuracy and precision in the location of these sensors may be needed for thermal effector operation to cooperate with the system's calibration. However, consistent location of these sensors may be difficult in the manufacturing process. Furthermore, the automotive industry is concerned with cost reduction, so additional sensors with their attendant costs are typically not a favorable solution. Sensors provided in or on compressible layers, such as a spacer layer in a seat, may be felt by occupants, negatively impacting comfort. Moreover, compressible layers expose sensors to repeated wear, which can diminish the integrity of the sensor over time.

There is a need for a system to control conductive thermal effectors based on dynamically estimated temperatures felt at surfaces by occupants. There is a need for a system to control convective thermal effectors based on dynamically estimated temperatures of airstreams at outlets.

There is a need for a system to utilize existing sensor and/or controller hardware to control thermal effectors.

There is a need for a system that provides control of thermal effectors to a dynamic surface temperature, unconstrained by pre-determined setpoints. There is a need for a system that provides control of thermal effectors to a dynamic airstream temperature, unconstrained by pre-determined setpoints.

There is a need for a system that obviates the need for calibrations to populate lookup tables.

There is a need for a system that provides for collaboration between thermal effectors to condition a common surface and share energy usage. There is a need for a system that provides for collaboration between thermal effectors to condition a common airstream and share energy usage.

There is a need for a system that provides for more rapid arrival at setpoints (e.g., temperature setpoints) selected by occupants, relative to conventional systems.

### SUMMARY

The present disclosure provides for a conditioning system that may address at least some of the needs identified above. The conditioning system may be operable in a vehicle. The conditioning system may comprise a thermal effector, a first local sensor associated with the thermal effector, and a controller in signaling communication with the thermal effector and the first local sensor. The controller or an additional controller may dynamically estimate a thermal condition remote from and at least partially influenced by the thermal effector. The dynamic estimation may be based on a first temperature sensed by the first local sensor and optionally a second temperature sensed by an optional second local sensor. The present disclosure contemplates that the optional second sensor may or may not be part of the system. Whether or not the optional second local sensor is a part of the system, inputs provided therefrom may be employed by the system. The controller controls the thermal effector based on the dynamically estimated thermal condition.

The controller may be a thermal effector controller local to the thermal effector.

The conditioning system may comprise two or more of the thermal effector and two or more of the controller. Each of the two or more controllers may be local to each of the two or more thermal effectors. The two or more thermal effectors may condition a common surface and/or a common airstream, or the two or more thermal effectors condition a common vehicle component.

The two or more controllers may communicate a power consumption signal amongst each other. The power consumption signal may be indicative of power consumed by the two or more thermal effectors. The two or more thermal effectors may contribute equally to power consumption, or the two or more thermal effectors function in a hierarchy with each successive thermal effector contributing progressively less to power consumption.

Each of the two or more controllers may dynamically estimate the thermal condition.

One of the two or more controllers, functioning as parent controllers, may dynamically estimate the thermal condition and provide the same to the remainder of the two or more controllers, functioning as child controllers.

Communication between the two or more controllers may be undertaken via a local interconnect network bus.

The additional controller may be a dedicated system controller local to a vehicle component that is conditioned by the system.

The additional controller may function as a parent controller, dynamically estimate the thermal condition and provide the same to the controller, functioning as a child controller.

Communication between the controller and the additional controller may be undertaken via a local interconnect network bus.

The thermal condition may include a temperature of a surface, a temperature of an airstream, or both. The surface may be on a seat cushion, a seat back, a headrest, a door panel, a center console, a steering wheel, a gear shifter, an instrument panel, a headliner, a floor, a leg panel, or any combination thereof. The airstream may emanate from a vent in or on a seat cushion, a seat back, a headrest, a door panel, a center console, a steering wheel, a gear shifter, an instrument panel, a headliner, a floor, a leg panel, or any combination thereof. The vent may communicate with a containment device.

The thermal condition may be the temperature of the surface, and the controller or the additional controller may determine a first heat transfer rate with respect to the surface. The first heat transfer rate may be directly or indirectly influenced by the thermal effector. The first heat transfer rate may ultimately be determined by an input from the first local sensor. The dynamically estimated thermal condition may be based on the first heat transfer rate.

The controller or the additional controller may determine a second heat transfer rate with respect to the surface. The second heat transfer rate may be influenced by a cabin environment, and/or the controller may determine a third heat transfer rate with respect to the surface. The third heat transfer rate may be influenced by an occupant. The second heat transfer rate may be ultimately determined by an input indicative of a temperature of the cabin environment. The third heat transfer rate may ultimately be determined by an input indicative of a temperature of the occupant. The dynamically estimated thermal condition may be based on the second and/or third heat transfer rate.

The thermal condition may be the temperature of the airstream, and the controller or the additional controller may determine a first heat transfer rate with respect to the airstream. The first heat transfer rate may be directly or indirectly influenced by the thermal effector. The first heat transfer rate may be ultimately determined by an input from the first local sensor. The dynamically estimated thermal condition may be based on the first heat transfer rate.

The controller or the additional controller may determine a second heat transfer rate with respect to the airstream. The second heat transfer rate may be influenced by a cabin environment. The second heat transfer rate may be ultimately determined by an input indicative of a temperature of the cabin environment. The dynamically estimated thermal condition may be based on the second heat transfer rate.

The first local sensor may be located on or proximate to the thermal effector.

The thermal effector may be located in or on a vehicle component. The vehicle component may include a seat cushion, a seat back, a headrest, a door panel, a center console, a steering wheel, a gear shifter, an instrument panel, a headliner, a floor, a leg panel, a conduit, or any combination thereof.

The thermal effector may include a resistance element, a thermoelectric device, or both.

Controlling the thermal effector may include regulating power to the thermal effector and/or reversing the polarity of the thermal effector to achieve a setpoint temperature. Said control may be based on the dynamically estimated thermal condition and the setpoint temperature.

The conditioning system may comprise a human-machine interface. The human-machine interface may be adapted to receive a setpoint temperature, a setpoint mass air flow, or both.

The conditioning system may comprise a blower and/or a valve. The controller may cooperate in controlling a blower speed and/or a valve position to achieve a setpoint mass air flow and/or a setpoint temperature. Said control may be based on the temperature dynamically estimated by the controller or the additional controller.

The controller or the additional controller may receive from an existing vehicle controller: a setpoint temperature, a setpoint mass air flow, a temperature sensed by a second local sensor, a power budget, an occupancy status, an operation mode, or any combination thereof.

### BRIEF DESCRIPTIONS OF THE DRAWINGS

FIG. 1A illustrates a schematic of the system of the present teachings.

FIG. 1B illustrates a schematic of the system of the present teachings.

FIG. 1C illustrates a schematic of the system of the present teachings.

FIG. 2 illustrates a schematic of the system of the present teachings.

FIG. 3 illustrates graphs comparing the estimated surface temperature according to the present teachings with the actual measured surface temperature, pre-calibration and post-calibration.

FIG. 4 illustrates graphs comparing the estimated surface temperature according to the present teachings with the actual measured surface temperature, pre-calibration and post-calibration.

FIG. 5 illustrates graphs comparing the estimated airstream temperature according to the present teachings with the actual measured airstream temperature, pre-calibration and post-calibration.

### DESCRIPTION

The present disclosure provides for a system for conditioning one or more vehicle components. The conditioning may be driven by one or more thermal effectors. The thermal effectors may condition a surface, an airstream, or both. The surface and/or airstream may function to exchange heat with an occupant. By way of example, an occupant may contact a conditioned surface, be contacted by radiation emanating from a surface, and/or be contacted by an airstream. The surface and/or airstream may be directly or indirectly in thermal communication with one or more thermal effectors. One or more elements may be disposed between the thermal effector and the surface and/or airstream. The elements may convey heat between the thermal effector and the conditioned medium. The elements may include material layers, heat exchangers, or both.

The surface may be any surface of a vehicle component. The surface may be located within the cabin of the vehicle. The surface may be on a trim layer. That is, the exposed, visible surfaces of the vehicle commonly contacted by occupants (e.g., seat leather or fabric). The vehicle component may include any component contacted by an occupant. The surface may exchange heat with one or more thermal effectors, one or more material layers, an occupant, a cabin environment, radiative heat sources, or any combination thereof. As referred to herein, cabin environment may mean the air located within the cabin of the vehicle where occupants are seated.

The airstream may be expelled at an outlet (e.g., a vent). The outlet may be located in a vehicle component. The airstream may be generated by one or more blowers. Prior to reaching the outlet, the airstream may travel through one or more conduits and/or exchange heat with the one or more conduits. The airstream may be directed into one or more conduits and/or mixed with one or more other airstreams by one or more valves. One or more heat exchangers and/or thermal effectors may be disposed in or on the one or more conduits. The airstream may exchange heat with the one or more thermal effectors and/or heat exchangers. The airstream may be provided to the cabin of a vehicle. The airstream may thermally communicate with the cabin environment and/or one or more occupants.

The vehicle component may include, but is not limited to, a steering wheel, a gear shifter, a seat, a headrest, a door panel, an instrument panel, a headliner, a center console, a leg panel, a floor, a pillar, or any combination thereof. The seat may include a back upon which an occupant's back rests. The seat may include a seat upon which an occupant's rear rests. The vehicle component may be any component within the cabin of the vehicle. The vehicle component may be climate controlled. That is, the component may be heated and/or cooled to provide comfort to occupants.

Non-limiting examples of climate controlled steering wheels are described in U.S. Pat. Nos. 6,727,467 B1 and 9,399,480 B2, incorporated herein by reference for all purposes. A non-limiting example of a climate controlled gear shifter is described in U.S. Pat. No. 9,298,207 B2, incorporated herein by reference for all purposes. Non-limiting examples of climate controlled seats are described in U.S. Patent No. 7,338,117 B2 (describing aventilated seat) and U.S. Pat. No. 7,196,288 B2 (describing a conductively heated seat), incorporated herein by reference for all purposes. A non-limiting example of a climate controlled headrest is described in U.S. Pat. No. 9,333,888 B2, incorporated herein by reference for all purposes.

Non-limiting examples of vents located in or on seats are described in U.S. Publication Nos. 2017/0129375 A1 and 2021/0276463 A1, incorporated herein by reference for all purposes. A non-limiting example of a vent located in a headrest is described in U.S. Pat. No. 9,333,888 B2, incorporated herein by reference for all purposes. A non-limiting example of a vent located in a door is described in U.S. Publication No. 2017/0182861 A1, incorporated herein by reference for all purposes. A non-limiting example of vents located in a headliner is described in U.S. Pat. No. 10,266,031 B2, incorporated herein by reference for all purposes. Non-limiting examples of other systems for conditioning airstreams are described in U.S. Pat. Nos. 9,103,573 B2 and 9,555,686 B2, incorporated herein by reference for all purposes.

The temperature of the surfaces and/or airstream may be regulated by one or more thermal effectors (“effectors”).

The thermal effectors thermally communicating with surfaces may be conductive effectors. The conductive effectors may generate heat that is ultimately conducted to a surface contacted by occupants. The conductive effectors may absorb heat from their surroundings that ultimately absorb heat from a surface contacted by occupants. A non-limiting example of a conductive effector is described in U.S. Pat. No. 9,657,963 B2 (describing a heater mat), incorporated herein by reference for all purposes.

The thermal effectors thermally communicating with airstreams may be convective effectors. The convective effectors may heat and/or cool one or more airstreams that are delivered to occupants and/or one or more surfaces. Convective effectors that condition a surface may deliver an airflow to a hermetically sealed or at least partially hermetically sealed containment device (e.g., containment bag). Thus, conditioned air may be delivered to the containment device and air within the containment device may cause heat exchange with one or more mediums in contact with the containment device. The thermal effectors may cooperate with one or more heat exchangers. The heat exchangers may function to thermally communicate with an airstream. The heat exchangers may be fabricated from a thermally conductive material (e.g., thermal conductivity of about 100 W/(m·K) or more, more preferably about 200 W/(m·K) or more, or even more preferably about 300 W/(m·K) or more). The heat exchanger may be adapted with a surface area over which an airstream travels. To this end, the heat exchanger may include a plurality of fins or corrugations, although any other suitable shape is contemplated by the present teachings. Non-limiting examples of suitable heat exchangers are described in U.S. Pat. Nos. 7,178,344 B2 and 8,143,554 B2, incorporated herein by reference for all purposes.

Heating and/or cooling may be achieved by the operation of one or more resistance elements, thermoelectric devices, or both. A non-limiting example of a resistance element is described in U.S. Pat. No. 9,657,963 B2, incorporated herein by reference for all purposes. A non-limiting example of a thermoelectric device is described in U.S. Pat. No. 9,857,107 B2, incorporated herein by reference for all purposes. The thermoelectric device may comprise two surfaces, one of which being the “hot” side and the other being the “cold” side, relative to each other. By reversing the polarity of power provided to the thermoelectric device, the relative temperatures of each side may flip. Heating and/or cooling may utilize a fluid medium (e.g., air) that transports heat to and/or from an occupant, vehicle component, or both. The fluid medium may be moved by one or more blowers. Non-limiting examples of blowers are described in International Publication No. WO 2008/115831 A1 and U.S. Pat. No. 9,121,414 B2, incorporated herein by reference for all purposes.

The thermal effectors may be controlled to provide heating and/or cooling that corresponds with an operation mode, a setpoint temperature, a setpoint mass air flow, or any combination thereof. The operation mode, setpoint temperature, and/or setpoint mass air flow may be determined by occupants' interaction with a human-machine interface (HMI). The operation mode, setpoint temperature, and/or setpoint mass air flow may be determined by occupants' actuation of one or more knobs, buttons, dials, toggles, switches, the like, or any combination thereof. The operation mode, setpoint temperature, and/or setpoint mass air flow may be determined by an autonomous control system. These systems may account for one or more sensor inputs and regulate the setpoints autonomously via one or more controllers. The operation mode may be ON or OFF. The operation mode may designate a heating, cooling, and/or mass air flow level (e.g., level 1, 2, 3, etc.). Thermal effectors, blowers, and/or valves may be operated by regulating power thereto (e.g., pulse width modulation duty cycle, constant current control, and the like) and/or reversing polarity thereof (e.g., reversing polarity of a thermoelectric device). The duty cycle may operate to ramp-up to achieve, and then maintain the setpoint temperature, at least until the operation mode changes or the setpoint changes by the direction of the occupant. The duty cycle may operate in accordance with the difference between a dynamically estimated surface temperature and the setpoint temperature.

The system of the present disclosure may at least partially rely on dynamic estimations of temperatures. Dynamic estimations of surface temperatures are disclosed in U.S. Application No. 63/316,762. Dynamic estimations of airstream temperatures are disclosed in U.S. Application No. 63/316,779. The dynamic estimation may be based on one or more heat transfer rates, a thermal capacitance, a program cycle time, and either an initial temperature or a temperature from a prior program cycle. The rate of heat transfer between two mediums is generally based on the difference in temperature between the two mediums, the surface area across which the heat transfer is occurring, one or more thermal resistances, or any combination thereof. The thermal capacitance, cycle time, thermal resistance, surface area, or any combination thereof may be pre-determined values. Other pre-determined values may be appreciated by the present teachings. Current and prior program cycle temperatures may be provided by prior dynamic estimations or sensor inputs. Thus, the heat transfer rates and dynamically estimated temperatures through any number of successive thermal mediums may be determined based on just one variable input (e.g., thermal effector temperature).

The system of the present disclosure may control one or more thermal effectors based on said dynamic estimation. The system may comprise one or more controllers that cooperate to control the thermal effectors. The control methodology is disclosed in U.S. Application No. 63/337,645.

Estimation, as referred to herein, may mean the calculation of a parameter understanding that the result of such calculation may not exactly correspond with the actual value (e.g., temperature of a surface). Thus, the result of such calculation may be an estimate of the actual value. The system and method of the present disclosure may provide an estimate that deviates about 10% or less, more preferably 5% or less, or even more preferably 1% or less from the actual value. The foregoing is applicable to all embodiments.

Any calculation, dynamic estimation, storage, transmission, determining, and/or obtaining step recited herein may be performed by one or more controllers. The controllers may include one or more thermal effector controllers, dedicated system controllers, existing vehicle controllers, or any combination thereof. Calculations and dynamic estimations may be performed by one controller or distributed between a plurality of controllers. Any non-transient values (e.g., pre-determined values) or inputs may be stored locally on and/or remote from the controllers. Any inputs that are calculated or estimated from other modules may be stored locally on and/or remote from the controllers. Any inputs that are calculated or estimated from other modules may be stored temporarily on the controllers. Any calculated or estimated inputs from other modules may be replaced or updated by newly provided inputs that are calculated or estimated from other modules. The foregoing is applicable to all embodiments.

Any communication or transmission between different controllers, sensors, and/or other devices may be via a local interconnect network (LIN) bus. Communications or transmissions may occur from a sensor to a controller or from a controller to another controller. By way of example but not limitation, an occupancy sensor may transmit an occupancy status to a vehicle controller, and then the vehicle controller may transmit the occupancy signal to a dedicated effector controller. The foregoing is applicable to all embodiments.

Vehicle, as referred to herein, may mean any automobile, recreational vehicle, sea vessel, air vessel, the like, or any combination thereof. While the present disclosure discusses the conditioning of a vehicle and surfaces thereof, the teachings herein may be adapted for any space that is conditioned with surfaces that may directly and/or radiatively thermally communicate with individuals. By way of example, the present teachings may be applied to furniture (e.g., chairs and beds), buildings, the like, or any combination thereof. The foregoing is applicable to all embodiments.

Any reference to heat transfer rates and dynamically estimated temperatures may refer to the current heat transfer rates and current dynamically estimated temperatures. That is, these values may be ultimately determined by one or more sensor inputs from one or more sensors at current time and/or one or more calculations performed at current time (e.g., from an immediately prior program cycle and/or a current program cycle). The foregoing is applicable to all embodiments.

### Controllers and System Architecture

One or more controllers may dynamically estimate the temperature of a surface and/or airstream, as described hereunder. One or more controllers may determine one or more heat transfer rates relative to a surface and/or airstream, as described hereunder. One or more controllers may regulate the temperature of a surface and/or airstream, as described hereunder.

Controllers may be referred to herein as electronic control units (“ECU”). The controllers may include existing vehicle controllers, dedicated system controllers, thermal effector controllers, or any combination thereof.

Dedicated system controllers may be referred to herein as location controllers. That is, the location controller may be associated with one or more thermal effectors acting upon a specific vehicle component (e.g., a seat). The location controller may be located on or in the vehicle component conditioned by the associated thermal effectors, or remote from the vehicle component conditioned by the associated thermal effectors.

The thermal effector controllers may be located on or proximate to (e.g., no more than 5 cm, more preferably no more than 2 cm, or even more preferably no more than 1 cm) the thermal effector which it controls. Each thermal effector may be associated with a thermal effector controller. A thermal effector controller may control more than one thermal effector.

One or more estimations, determinations, and/or calculations disclosed herein may be performed by one or more of the controllers. In one aspect, the dynamic estimation, heat transfer rate determination, and/or temperature regulation may be performed by the dedicated system controller. In one aspect, the dynamic estimation heat transfer rate determination, and/or temperature regulation may be performed by the thermal effector controller.

The location controller may function as a parent controller and the thermal effector controllers may function as child controllers. One thermal effector controller may function as a parent controller and any other thermal effector controllers may function as child controllers.

The system may comprise one or more dedicated system controllers and/or one or more thermal effector controllers. The dynamic estimation, heat transfer rate determination, and/or temperature regulation may be performed by the dedicated system controller. The one or more thermal effector controllers may direct the power regulation of the thermal effector they are associated with. The one or more thermal effector controllers may communicate power consumption therebetween to cooperate in conditioning a surface and/or an airstream.

The system may comprise one or more thermal effector controllers. The dynamic estimation, heat transfer rate determination, and/or temperature regulation may be performed by the thermal effector controllers. In one aspect, a parent thermal effector controller performs the dynamic estimation, heat transfer rate determination, and/or temperature regulation, and outputs therefrom are provided to child thermal effector controllers. The one or more thermal effector controllers may direct the power regulation of the thermal effector they are associated with. The one or more thermal effector controllers may communicate power consumption therebetween to cooperate in conditioning a surface and/or an airstream.

The location controller may be calibrated with respect to the targeted time to reach target temperature, the thermal capacitance of elements in the thermal exchange system, the thermal resistance of elements in the thermal exchange system, or any combination thereof. Thus, the time to target, thermal resistance, thermal capacitance, and the like may not be the actual values, but rather adjusted to obtain the desired performance of the system.

The system may dynamically estimate a temperature of a surface and/or an airstream, dynamically estimate a temperature of one or more elements associated with the surface (e.g., a material layer) and/or the airstream (e.g., a conduit), determine one or more heat transfer rates, regulate the temperature of a surface and/or an airstream, regulate power to one or more thermal effectors, or any combination thereof. Each of these functions may be performed respectively by individual modules associated with a controller. One or more of these functions may be performed respectively by a module associated with a controller. The term module, as referred to herein, may refer to computer-executable instructions stored in a memory storage medium, more particularly a non-transient memory storage medium, and carried out by processing componentry of a controller. Thus, where a particular module is referred to in association with a particular controller, that controller performs the function specified by the module.

### Dynamically Estimating Surface Temperature

The system may dynamically estimate the temperature of a surface (e.g., a trim layer). One or more controllers may dynamically estimate the temperature of a surface. One or more dedicated system controllers, thermal effector controllers, or both may dynamically estimate the surface temperature. The surface temperature may be dynamically estimated according to U.S. Provisional Application No. 63/316,762, incorporated herein by reference for all purposes.

The surface temperature may be dynamically estimated based on the heat transfer rates (\dot{Q}) of the surface to or from one or more surrounding mediums (e.g., a material layer, an occupant, a cabin environment, and the like).

A temperature change per unit time (\dot{T}) may be determined from one or more heat transfer rates of the surface to or from one or more surrounding mediums and/or a thermal capacitance. With a known cycle time (t), a temperature change (ΔT; represented by parentheticals in Eq. A) may be determined. The temperature change (ΔT) from the initial surface temperature or the prior dynamically estimated surface temperature (T₍ₙ₋₁₎) may determine the dynamically estimated surface temperature (Tₑₛₜ) at current time. The surface temperature may be dynamically estimated according to the following equation.

$${T}_{est} = {T}_{( n - 1 )} + ( \dot{T} \times t ) \qquad Eq . A$$

The program cycle time (e.g., 1 second or less, 50 milliseconds or less, 30 milliseconds or less, or even 10 milliseconds or less) may be measured (e.g., by a timer) and/or stored in a memory storage medium. The memory storage medium may be a non-transient memory storage medium.

The initial surface temperature may be determined at start-up of the vehicle. The initial surface temperature may be assumed to be equal to the temperature sensed by a local sensor (e.g., a sensor adapted to sense cabin environment temperature) upon start-up. These sensors may include those disposed in the cabin, on heating elements, in vent outlets, or otherwise. Any sensors located in the vehicle may provide the temperature at start-up. After start-up, the prior surface temperature may be the dynamically estimated surface temperature from a prior program cycle.

The estimated surface temperature may be employed in the operation of one or more thermal effectors. That is, based upon the dynamic estimation of the surface temperature and in view of the setpoint temperature, the power regulation (e.g., pulse width modulation duty cycle, constant current control, or the like) of one or more thermal effectors may be controlled to achieve the setpoint temperature. Based upon the dynamic estimation of the surface temperature in view of the setpoint temperature, the power regulation (e.g., pulse width modulation duty cycle, constant current control, or the like) and/or ON/OFF command of one or more blowers and/or one or more valves may be controlled to achieve the setpoint temperature.

The system may determine one or more heat transfer rates. One or more controllers may determine the heat transfer rates. One or more dedicated system controllers, thermal effector controllers, or both may determine the heat transfer rates. The heat transfer rates may be determined according to U.S. Provisional Application No. 63/316,762, incorporated herein by reference for all purposes.

The surface may exchange heat with one or more mediums in contact with the surface. The mediums may include one or more material layers (e.g., a spacer layer), one or more thermal effectors, an occupant, a cabin environment, or any combination thereof.

The material layers may include a spacer layer. The spacer layer may function to protect the thermal effectors and/or the sensors associated therewith, provide comfort to occupants, regulate the heat transfer rate from thermal effectors by virtue of the material and thickness of the spacer layers, or any combination thereof. The material layers may comprise one or more fabrics, films, leathers, foams, meshes, air pockets, or any combination thereof.

Typically, one or more thermal effectors are separated from the surface by one or more material layers (e.g., a spacer layer). However, the present disclosure contemplates that one or more thermal effectors thermally communicate directly with the surface.

An occupant may contact (e.g., sit upon) the surface. The surface may radiate heat towards an occupant. In the case of heat radiation, the heat transfer rate between an occupant and the surface may not be accounted for. Whether or not an occupant contacts the surface, typically at least a portion of the surface thermally communicates with the air of the cabin environment. However, the present disclosure contemplates that all of a surface may be contacted by an occupant.

The cabin environment may thermally communicate with the surface. Where a surface is not contacted (e.g., sit upon) by an occupant, the entire surface may thermally communicate with the cabin environment. Where a surface is contacted by an occupant, one or more portions of the surface may thermally communicate with the occupant and one or more other portions of the surface may thermally communicate with the cabin environment.

Thermal effectors, material layers, occupants, and the cabin environment may be referred to herein as mediums. That is, mediums that exchange heat with the surface.

The heat transfer rates relative to the surface (\dot{Q}) may be determined based on the temperature of the surface (T_{surf}), the temperature of the medium exchanging heat with the surface (T_{med}), the surface area through which heat is transferred (A_{surf}), the thermal resistance between the surface and the medium exchanging heat with the surface (R), or any combination thereof. The heat transfer rates may be calculated according to the following equation.

$$\dot{Q} = \frac{( {T}_{surf} - {T}_{med} ) \times {A}_{surf}}{R} \qquad Eq . B$$

The thermal resistance may be a pre-determined value. The value may be stored in and/or obtained from a memory storage medium, more particularly a non-transient memory storage medium. The thermal resistance may be assigned based upon particular vehicle makes, models, model years, trim levels, or any combination thereof. The thermal resistance may be unique to different materials, layer thicknesses, and the like. The thermal resistance may depend on geographic region, season, the body part being conditioned, or any combination thereof. The thermal resistance may reflect whether the vehicle component (e.g., seat) is occupied (e.g., compressed by an occupant) or unoccupied (e.g., un-compressed by an occupant). The occupancy status may be provided by existing sensors in the vehicle, such as occupancy sensors for the operation of air bags. Where the heat transfer rate between the surface and the cabin environment is determined, thermal resistance may be that of free convective air. Where the heat transfer rate is between an occupant and the surface, the thermal resistance may be that of skin, clothing, or both.

Occupancy status may determine whether heat transfer rate to or from a surface is to be considered relative to an occupant, a cabin environment, or both. Occupancy status may determine what proportion of the surface area through which heat transfer occurs is attributable to the occupant, the cabin environment, or both.

The surface area may be a pre-determined value. The value may be stored in and/or obtained from a memory storage medium, particularly a non-transient memory storage medium. The surface area may be assigned based upon particular vehicle makes, models, model years, trim levels, or any combination thereof. By way of example, the dimensions of a seat for one model may be different from the dimensions of a seat for another model. The surface area may be delineated by one or more dimensions (e.g., length and width) of one or more thermal effectors. The surface area may be delineated by the surface area of the vehicle component that is contacted by an occupant and/or the cabin environment. By way of example, while an occupant is seated, the area between an occupant's legs and the area around the peripheral edges of the seat may thermally communicate with the cabin environment.

Given industry concerns over cost and manufacturing complexity, not all elements in the thermal exchange system described herein have dedicated sensors associated therewith. The temperatures of elements not monitored by a dedicated sensor may be assumed equal to the temperature sensed by a local sensor upon start-up of the vehicle. The temperatures of elements not monitored by a dedicated sensor may be provided by a dynamic estimation (see Eq. C, below) from a prior program cycle after start-up. The present disclosure does not foreclose the possibility that a vehicle may comprise a sensor for sensing these elements. In this case, the dynamic estimation of their temperatures may not be necessary.

The thermal effector temperature may be provided by an input from one or more sensors (e.g., NTC sensor). Thermal effectors are typically provided with at least one sensor. The thermal effector temperature may be determined at soak. That is, when a maintained setpoint temperature of a previous cycle is achieved after ramp-up of the temperature.

The cabin environment temperature may be obtained from one or more local sensors, an estimation provided by another vehicle system, or both.

The surface temperature may be assumed equal to the temperature sensed by a local sensor prior to start-up of the vehicle. The surface temperature may be obtained from a dynamic estimation (see Eq. C) after start-up of the vehicle. The dynamic estimation may be from a prior program cycle.

The material layer temperature may be assumed equal to the temperature sensed by a local sensor prior to start-up of the vehicle. The material layer temperature may be obtained from a dynamic estimation (see Eq. C) after start-up of the vehicle. The dynamic estimation may be from a prior program cycle.

The skin temperature of an occupant may be set to a fixed value (e.g., a value within the normal human skin temperature range of 33° C. to 37° C.) prior to and/or after start-up of the vehicle. The skin temperature of an occupant may be provided by a dynamic estimation (see Eq. C) after start-up of the vehicle. The dynamic estimation may be from a prior program cycle. The skin temperature may be modelled as a function of surface temperature, cabin environment temperature, thermal effector operation, or any combination thereof.

The dynamic temperature estimations of elements not monitored by a dedicated sensor can be determined from a stepwise progression of heat transfer rate determinations (see Eq. B) and dynamic temperature estimations (see Eq. C) starting from an element with a sensed or otherwise assumed temperature and progressing through each successive element in the system in thermal communication with each other until ultimately the surface is reached. By way of example, the heat transfer rate between a thermal effector and a material layer may be determined based upon the sensed temperature of the thermal effector and the dynamically estimated temperature of the material layer may be determined based, at least in part, upon said heat transfer rate. The same principle may be applied to any number of material layers disposed between the thermal effector and the surface.

One or more thermal effectors may exchange heat with the same material layer or the surface. By way of example, a first thermal effector may exchange heat with the left side of a layer (e.g., material layer) and a second thermal effector may exchange heat with the right side of the same layer (e.g., material layer). In this arrangement, multiple different heat transfer rates between a material layer and each individual thermal effector may be determined and employed in Eq. C.

Two or more thermal effectors may be stacked one over the other. Two or more, three or more, or even four or more thermal effectors in a stacked arrangement may be contemplated by the present teachings. In this arrangement, the thermal effectors may be treated as discrete layers. For example, the heat transfer rate from a first thermal effector to a second thermal effector and then the heat transfer rate from the second thermal effector to a material layer may be calculated in a similar manner as provided above.

The system may dynamically estimate the temperature of one or more elements. One or more controllers may dynamically estimate the temperature of one or more elements. One or more dedicated system controllers, thermal effector controllers, or both may dynamically estimate the temperature of one or more elements. The temperature may be dynamically estimated according to U.S. Provisional Application No. 63/316,762, incorporated herein by reference for all purposes. The dynamic estimation may be particularly advantageous where elements in the thermal system are not sensed by any local sensors. This may apply to material layers, skin of an occupant, or both.

The dynamic temperature estimation may be determined from the initial temperature or the prior dynamically estimated temperature of the element (T₍ₙ₋₁₎), one or more heat transfer rates relative to the element (\dot{Q}), the thermal capacitance of the element (C) (e.g., the thermal capacitance of a material layer or of the skin of an occupant), the time between program cycles (Δt), or any combination thereof. The temperature may be dynamically estimated according to the following equation.

$${T}_{est} = {T}_{( n - 1 )} + \frac{\sum \dot{Q}}{C} \times Δ t \qquad Eq . C$$

The program cycle time (e.g., 1 second or less, 50 milliseconds or less, 30 milliseconds or less, or even 10 milliseconds or less) may be measured (e.g., by a timer) and/or stored in a memory storage medium. The memory storage medium may be a non-transient memory storage medium.

The thermal capacitance may be a pre-determined value. The value may be stored in and/or obtained from a memory storage medium, particularly a non-transient memory storage medium. The thermal capacitance may be assigned based upon particular vehicle makes, models, model years, trim levels, or any combination thereof. The thermal capacitance may be unique to different materials, layer thicknesses, and the like.

The initial temperature may be determined at start-up of the vehicle. The initial temperature may be assumed to be equal to the temperature sensed by a local sensor (e.g., a sensor adapted to sense ambient cabin air temperature) upon start-up of the vehicle. These sensors may include those disposed in the cabin, on heating elements, in vent outlets, or otherwise. Any sensors located in the vehicle may provide the temperature at start-up. After start-up, the prior temperature may be the dynamically estimated temperature from a prior program cycle.

The thermal effector temperature may be provided by an input from one or more sensors (e.g., NTC sensor). Thermal effectors are typically provided with at least one sensor.

The cabin environment temperature may be obtained from one or more local sensors, an estimation provided by another vehicle system, or both.

The surface temperature may be assumed equal to the temperature sensed by a local sensor prior to start-up of the vehicle. The surface temperature may be obtained from a dynamic estimation after start-up of the vehicle.

The skin temperature of an occupant may be set to a fixed value (e.g., a value within the normal human skin temperature range of 33° C. to 37° C.) prior to and/or after start-up of the vehicle. The skin temperature may be determined for specific body parts, as disclosed hereinbefore. The location of the body part within one or more strata of the cabin may be considered, as disclosed hereinbefore.

The heat transfer rates relative to a material layer may include the heat transfer rate between one or more thermal effectors and the material layer, the heat transfer rate between the material layer and the surface, the heat transfer rate between the material layer and another material layer, or any combination thereof. Other heat transfer rates to and/or from the material layer may be realized by the present disclosure.

The heat transfer rates relative to an occupant may include the heat transfer between the occupant and the surface, the heat transfer rate between the occupant and the cabin environment, the heat transfer between the occupant and radiative heat sources (e.g., the sun), or any combination thereof. Other heat transfers to and/or from the occupant may be realized by the present disclosure.

### Regulating Surface Temperature

The system may regulate the temperature of a surface. One or more controllers may regulate the temperature of a surface. One or more dedicated system controllers, thermal effector controllers, or both may regulate the surface temperature. The surface temperature may be regulated according to U.S. Provisional Application No. 63/337,645, incorporated herein by reference for all purposes.

The surface temperature may be regulated by one or more conductive and/or convective thermal effectors. One example of a suitable conductive thermal effector may be a resistance heater mat (e.g., disposed within a seat). One example of a suitable convective effector may be a thermoelectric device that conditions an airstream delivered to a bag (e.g., a bag disposed within a seat).

Ultimately, regulation of the surface temperature, by one or more thermal effectors, may be determined by the dynamically estimated surface temperature at a current point in time and a setpoint temperature. That is, the quantity of energy supplied to one or more thermal effectors and the amount of time to supply said energy in order to effectuate the setpoint temperature may be ultimately determined by the difference between the current dynamically estimated temperature and the setpoint temperature.

The dynamically estimated surface temperature (T_{surf-est}) and setpoint temperature (T_{surf-set}) may determine the temperature change (ΔT_{surf}; represented by the parenthetical in Eq. D). The temperature change (ΔT_{surf}) and target time it takes to achieve the setpoint temperature (tₜₒ₋ₛₑₜ) may determine the surface temperature rate of change (\dot{T}_{surf}; represented by bracketed portion in Eq. D). The target total heat transfer rate (\dot{Q}ₜₒₜ) into the surface to achieve the temperature rate of change (\dot{T}_{surf}) may be determined from the surface temperature rate of change (\dot{T}_{surf}) and the thermal capacitance (C_{surf}) of the surface. The target total heat transfer rate may be determined according to the following equation.

$${\dot{Q}}_{tot - tgt} = [ ( {T}_{surf - set} - {T}_{surf - est} ) \times {t}_{to - set} ] \times {C}_{surf} \qquad Eq . D$$

The dynamically estimated surface temperature may be determined as taught hereinbefore. The setpoint temperature may be received by a human-machine interface (HMI) and/or an autonomous control system.

The time it takes to achieve the setpoint temperature may be a fixed value or may vary. The time it takes to achieve the setpoint temperature may be stored in a memory storage medium, particularly a non-transient memory storage medium.

The thermal capacitance may be a pre-determined value. The value may be stored in and/or obtained from a memory storage medium, particularly a non-transient memory storage medium. The thermal capacitance may be assigned based upon particular vehicle makes, models, model years, trim levels, or any combination thereof. The thermal capacitance may be unique to different materials, layer thicknesses, and the like.

The system may determine the target material layer (e.g., spacer layer) temperature required to achieve a target heat transfer rate between the material layer and the surface. The target heat transfer rate between the material layer (e.g., a spacer layer) and the surface (\dot{Q}_{mat-tgt}; represented by parentheticals in Eq. E) may be determined from the target total heat transfer rate (\dot{Q}_{tot-tgt}) determined above and any other heat transfer rate relative to the surface (e.g., heat transfer rate between an environment and the surface (\dot{Q}ₑₙᵥ) and/or the heat transfer rate between an occupant and the surface (\dot{Q}_{occ})). Whether the other heat transfer rates relative to the surface are subtracted from or added to \dot{Q}_{tot-tgt}, may depend on whether the heat transfer is to or from the surface. The target material layer temperature (T_{mat-tgt}) required to achieve the target heat transfer rate between the material layer and the surface (\dot{Q}_{mat-tgt}) may be determined from the target heat transfer rate between the material layer and the surface (\dot{Q}_{mat-tgt}), the thermal resistance between the surface and the spacer (R_{surf-mat}), and the current dynamically estimated spacer temperature (Tₘₐₜ₋ₑₛₜ). The target spacer temperature may be determined according to the following equation.

$${T}_{mat - tgt} = [ ( {\dot{Q}}_{tot ‐ tgt} - {\dot{Q}}_{env} - {\dot{Q}}_{occ} ) \times {R}_{surf - mat} ] + {T}_{mat - est} \qquad Eq . E$$

The foregoing may be performed repeatedly until the target temperature of one or more thermal effectors is determined. Where only one material layer is present between the surface and the thermal effector, the target total heat transfer rate into/from the material layer by one or more thermal effectors to achieve the temperature rate of change of the material layer may be determined. Then, the target thermal effector temperature required to achieve the target heat transfer rate between the one or more thermal effectors and the material layer may be determined. Where multiple material layers are present between the surface and the thermal effector, the same procedure above may be repeated for each layer, where the setpoint temperature (Eq. D) of each successive layer in the system may be the target temperature (Eq. E) determined from the immediately antecedent calculation.

The present teachings contemplate that the one or more thermal effectors thermally communicate directly with the surface. In which case, Eq. D and Eq. E need only be performed as between the one or more thermal effectors and the surface.

The present teachings contemplate that more than one material layer may be disposed between the surface and one or more thermal effectors. In which case, Eq. D and Eq. E may be performed as between each layer in the system.

It may be appreciated that any thermal resistances, thermal capacitances, times to achieve the setpoint temperature, and the like may be unique to each element in the system (e.g., different materials have associated thermal resistances). These values may be pre-determined. These values may be stored in a memory storage medium, particularly a non-transient memory storage medium.

It may be appreciated that the identity of the “any other” heat transfer rate relative to the subject element in the system (e.g., \dot{Q}ₑₙᵥ and \dot{Q}_{occ}) may be unique to the subject layer. For example, a material layer thermally communicating with one or more thermal effectors may also thermally communicate with a surface or another material layer.

### Dynamically Estimating Airstream Temperature

The system may dynamically estimate the temperature of an airstream at or proximate to an outlet. One or more controllers may dynamically estimate the temperature of an airstream. One or more dedicated system controllers, thermal effector controllers, or both may dynamically estimate the airstream temperature. The airstream temperature may be dynamically estimated according to U.S. Provisional Application No. 63/316,779, incorporated herein by reference for all purposes.

The airstream temperature may be dynamically estimated based on the heat transfer rates (Q) of the airstream to or from one or more surrounding mediums (e.g., a heat exchanger, conduit, or both).

A temperature change per unit time (\dot{T}) may be determined from one or more heat transfer rates of the airstream to or from one or more surrounding mediums and/or a thermal capacitance. With a known cycle time (t), a temperature change (ΔT; represented by parentheticals in Eq. G) may be determined. The temperature change (ΔT) from the initial airstream temperature or the prior estimated airstream temperature (T₍ₙ₋₁₎) may determine the dynamically estimated airstream temperature (Tₑₛₜ). The airstream temperature may be dynamically estimated according to the following equation.

$${T}_{est} = {T}_{( n - 1 )} + ( \dot{T} \times t ) \qquad Eq . G$$

The program cycle time (e.g., 1 second or less, 50 milliseconds or less, 30 milliseconds or less, or even 10 milliseconds or less) may be measured (e.g., by a timer) and/or stored in a memory storage medium.

The initial airstream temperature may be determined at start-up of the vehicle. The initial airstream temperature may be assumed to be equal to the temperature sensed by a local sensor (e.g., a sensor adapted to sense ambient cabin air temperature) upon start-up of the vehicle. These sensors may include those disposed in the cabin, on heating elements, in vent outlets, or otherwise. Any sensors located in the vehicle may provide the temperature at start-up. After start-up, the prior airstream temperature may be the dynamically estimated airstream temperature from a prior program cycle.

The estimated airstream temperature may be employed in the operation of one or more thermal effectors. That is, based upon the dynamic estimation of the airstream temperature, the power regulation (e.g., pulse width modulation duty cycle, constant current control, or the like) of one or more thermal effectors may be controlled to achieve the setpoint temperature. Based upon the dynamic estimation of the airstream temperature, the power regulation (e.g., pulse width modulation duty cycle, constant current control, or the like) of one or more blowers and/or one or more valves may be controlled to achieve the setpoint temperature.

The system may determine one or more heat transfer rates relative. One or more controllers may determine the heat transfer rates. One or more dedicated system controllers, thermal effector controllers, or both may determine the heat transfer rates. The heat transfer rates may be determined according to U.S. Provisional Application No. 63/316,779, incorporated herein by reference for all purposes.

The airstream may exchange heat with one or more mediums in contact with the airstream. The mediums may include one or more conduits, one or more heat exchangers, or both.

The airstream may thermally communicate with the one or more conduits from the region where the airstream is expelled by a blower to the region where the airstream exits an outlet. The conduit may extend through one or more vehicle components. The temperature of the conduit may be influenced by the temperature applied to exterior surfaces of the conduit, the exterior surfaces opposing the surfaces contacting the airstream. The conduit may extend through a solid object (e.g., seat layers) and/or open space (e.g., open space defined by the interior portion of a dashboard). The solid object and/or open space may be referred to herein, with respect to the conduit, as an environment.

One or more heat exchangers may be located at least partially within a conduit. One or more heat exchangers may be disposed in one or more locations along the length of the conduit. The airstream may travel over and/or through the heat exchanger. The heat exchangers may thermally communicate with one or more thermal effectors. The present disclosure contemplates that the airstream directly thermally communicates with one or more thermal effectors. The thermal effector may be integral with a heat exchanger. One or more mediums (e.g., thermal paste) may be disposed between the heat exchanger and the thermal effector.

Thermal effectors, conduits, and heat exchangers may be referred to herein as mediums. That is, mediums that exchange heat with the airstream.

The heat transfer rates relative to the airstream (\dot{Q}) may be determined based on the temperature of the airstream (Tₐᵢᵣ), the temperature of the medium exchanging heat with the airstream (T_{med}), the surface area through which heat is transferred (A_{surf}), the thermal resistance between the airstream and the medium exchanging heat with the airstream (R), or any combination thereof. The heat transfer rates may be calculated according to the following equation.

$$\dot{Q} = \frac{( {T}_{air} - {T}_{med} ) \times {A}_{surf}}{R} \qquad Eq . H$$

The thermal resistance may be a pre-determined value. The value may be stored in and/or obtained from a memory storage medium, more particularly a non-transient memory storage medium. The thermal resistance may be assigned based upon particular vehicle makes, models, model years, trim levels, or any combination thereof. The thermal resistance may be unique to different materials, layer thicknesses, and the like. The thermal resistance may be that of the free convective air.

The surface area may be a pre-determined value. The value may be stored in and/or obtained from a memory storage medium, particularly a non-transient memory storage medium. The surface area may be assigned based upon particular vehicle makes, models, model years, trim levels, or any combination thereof. By way of example, the dimensions of a conduit for one model may be different from the dimensions of a conduit for another model. The surface area may be delineated by one or more dimensions of the conduits (e.g., length of the cross-sectional outer perimeter and/or length which the conduit extends through the environment), heat exchangers, or both.

Given industry concerns over cost and manufacturing complexity, not all elements in the thermal exchange system described herein have dedicated sensors associated therewith. The temperatures of elements not monitored by a dedicated sensor may be assumed equal to the temperature sensed by a local sensor upon start-up of the vehicle. The temperatures of elements not having a sensor associated therewith may be provided by a dynamic estimation (see Eq. I, below) from a prior program cycle after start-up. The present disclosure does not foreclose the possibility that a vehicle may comprise a sensor for sensing these elements. In this case, the dynamic estimation of their temperatures may not be necessary.

The thermal effector temperature may be provided by an input from one or more sensors (e.g., NTC sensor). Thermal effectors are typically provided with at least one sensor. The thermal effector temperature may be determined at soak. That is, when a maintained setpoint temperature of a previous cycle is achieved after ramp-up of the temperature.

The heat exchanger temperature may be assumed equal to the temperature sensed by a local sensor upon start-up of the vehicle. The heat exchanger temperature may be provided by a dynamic estimation (see Eq. I) after start-up.

The environment (e.g., solid object and/or open space through which the conduit extends) temperature may be assumed equal to the temperature sensed by a local sensor.

The conduit temperature may be assumed equal to the temperature sensed by a local sensor upon start-up of the vehicle. The conduit temperature may be provided by a dynamic estimation (see Eq. I) after start-up. The dynamic estimation may be from a prior program cycle.

The airstream temperature may be assumed equal to the temperature sensed by a local sensor upon start-up of the vehicle. The airstream temperature may be provided by a dynamic estimation (see Eq. I) after start-up. The dynamic estimation may be from a prior program cycle.

The dynamic estimations of the temperature of elements not monitored by a dedicated sensor can be determined from a stepwise progression of heat transfer rate determinations (see Eq. H) and dynamic temperature estimations (see Eq. I) starting from an element with a sensed or otherwise assumed temperature and progressing through each successive element in the system in thermal communication with each other until ultimately the airstream is reached.

The system may dynamically estimate the temperature of one or more elements. One or more controllers may dynamically estimate the temperature of one or more elements. One or more dedicated system controllers, thermal effector controllers, or both may dynamically estimate the temperature of one or more elements. The temperature may be dynamically estimated according to U.S. Provisional Application No. 63/316,779, incorporated herein by reference for all purposes. The dynamic estimation may be particularly advantageous where elements in the thermal system are not sensed by any local sensors. This may apply to conduits, heat exchangers, or both.

The dynamic temperature estimation may be determined from the initial temperature or the prior dynamically estimated temperature of the element (T₍ₙ₋₁₎), one or more heat transfer rates relative to the element (\dot{Q}), the thermal capacitance of the element (C) (e.g., the thermal capacitance of a conduit or heat exchanger), the time between program cycles (Δt), or any combination thereof. The temperature may be dynamically estimated according to the following equation.

$${T}_{est} = {T}_{( n - 1 )} + \frac{\sum \dot{Q}}{C} \times Δ t \qquad Eq . I$$

The program cycle time (e.g., 1 second or less, 50 milliseconds or less, 30 milliseconds or less, or even 10 milliseconds or less) may be measured (e.g., by a timer) and/or stored in a memory storage medium. The memory storage medium may be a non-transient memory storage medium.

The thermal capacitance may be a pre-determined value. The values may be stored in and/or obtained from a memory storage medium, particularly a non-transient memory storage medium. The thermal capacitance may be assigned based upon particular vehicle makes, models, model years, trim levels, or any combination thereof. The thermal capacitance may be unique to different materials, layer thicknesses, and the like.

The initial temperature may be determined at start-up of the vehicle. The initial temperature may be assumed to be equal to the temperature sensed by a local sensor (e.g., a sensor adapted to sense ambient cabin air temperature) upon start-up of the vehicle. These sensors may include those disposed in the cabin, on heating elements, in vent outlets, or otherwise. Any sensors located in the vehicle may provide the temperature at start-up. After start-up, the prior temperature may be the dynamically estimated temperature from a prior program cycle.

The conduit temperature may be assumed to be equal to the temperature sensed by a local sensor upon start-up of the vehicle. The conduit temperature may be provided by a dynamic estimation after start-up.

The heat exchanger temperature may be assumed to be equal to the temperature sensed by a local sensor upon start-up of the vehicle. The heat exchanger temperature may be provided by a dynamic estimation taught herein after start-up.

The heat transfer rates relative to the conduit may include the heat transfer rate between the conduit and the environment, the heat transfer rate between the conduit and the airstream, or both. Other heat transfer rates to and/or from the conduit may be realized by the present disclosure.

The heat transfer rates relative to a heat exchanger may include the heat transfer rate between the one or more thermal effectors and the heat exchanger, the heat transfer rate between the airstream and the heat exchanger, or both. Other heat transfer rates to and/or from the heat exchanger may be realized by the present disclosure.

### Regulating Airstream Temperature

The system may regulate the temperature of an airstream. One or more controllers may regulate the temperature of an airstream. One or more dedicated system controllers, thermal effector controllers, or both may regulate the airstream temperature. The airstream temperature may be regulated according to U.S. Provisional Application No. 63/337,645, incorporated herein by reference for all purposes.

The airstream temperature may be regulated by one or more conductive and/or convective thermal effectors. One example of a suitable convective effector may be a thermoelectric device that conditions an airstream.

Ultimately, regulation of the airstream temperature, by one or more thermal effectors, may be determined by the dynamically estimated airstream temperature at a current point in time and a setpoint temperature. That is, the quantity of energy supplied to one or more thermal effectors and the amount of time to supply said energy in order to effectuate the setpoint temperature may be ultimately determined by the difference between the current dynamically estimated temperature and the setpoint temperature.

The dynamically estimated airstream temperature (Tₐᵢᵣ₋ₑₛₜ) and setpoint temperature (Tₐᵢᵣ₋ₛₑₜ) may determine the temperature change (ΔTₐᵢᵣ; represented by the parenthetical in Eq. J). The temperature change (ΔTₐᵢᵣ) and target time it takes to achieve the setpoint temperature (tₜₒ₋ₛₑₜ) may determine the airstream temperature rate of change (Tₐᵢᵣ; represented by bracketed portion in Eq. J). The target total heat transfer rate (\dot{Q}_{tot-tgt}) into the airstream to achieve the temperature rate of change (\dot{T}ₐᵢᵣ) may be determined from the airstream temperature rate of change (\dot{T}ₐᵢᵣ) and the thermal capacitance (Cₐᵢᵣ) of the airstream. The target total heat transfer rate may be determined according to the following equation.

$${\dot{Q}}_{tot - tgt} = [ ( {T}_{air - set} - {T}_{air - est} ) \times {t}_{to - set} ] \times {C}_{air} \qquad Eq . J$$

The dynamically estimated airstream temperature may be determined as taught hereinbefore. The setpoint temperature may be received by a human-machine interface (HMI) and/or an autonomous control system.

The time it takes to achieve the setpoint temperature may be a fixed value or may vary. The time it takes to achieve the setpoint temperature may be stored in a memory storage medium, particularly a non-transient memory storage medium.

The thermal capacitance may be a pre-determined value. The value may be stored in and/or obtained from a memory storage medium, particularly a non-transient memory storage medium. The thermal capacitance may be that of free convective air.

The system may determine the target heat exchanger temperature required to achieve the target heat transfer rate between the heat exchanger and the airstream. The target heat transfer rate between a heat exchanger and the airstream (\dot{Q}_{exch-tgt}; represented by parentheticals in Eq. K) may be determined from the target total heat transfer rate (\dot{Q}_{tot-tgt}) and any other heat transfer rate relative to the airstream (e.g., heat transfer rate between a conduit and the airstream (\dot{Q}_{con})). Whether the other heat transfer rates relative to the airstream are subtracted from or added to \dot{Q}_{tot-tgt}, may depend on whether the heat transfer is to or from the airstream. The target heat exchanger temperature (T_{exch-tgt}) required to achieve the target heat transfer rate between the heat exchanger and the airstream (\dot{Q}_{exch-tgt}) may be determined from the target heat transfer rate between the heat exchanger and the airstream (\dot{Q}_{exch-tgt}), the thermal resistance between the heat exchanger and the airstream (R_{air-exch}), and the current dynamically estimated heat exchanger temperature (T_{exch-est}). The target heat exchanger temperature may be determined according to the following equation.

$${T}_{exch - tgt} = [ ( {\dot{Q}}_{tot ‐ tgt} - {\dot{Q}}_{con} ) \times {R}_{air - exch} ] + {T}_{exch - est} \qquad Eq . K$$

The foregoing may be performed repeatedly until the target temperature of one or more thermal effectors is determined. Where only one element is present between the airstream and the thermal effector, the target total heat transfer rate into/from the element by one or more thermal effectors to achieve the temperature rate of change of the element may be determined. Then, the target thermal effector temperature required to achieve the target heat transfer rate between the one or more thermal effectors and the element may be determined. Where multiple elements are present between the airstream and the thermal effector, the same procedure may be repeated for each element, wherein the setpoint temperature (Eq. J) of each successive element in the system may be the target temperature (Eq. K) determined from the immediately antecedent calculation.

The present teachings contemplate that the one or more thermal effectors thermally communicate directly with the airstream. In which case, Eq. J and Eq. K need only be performed as between the one or more thermal effectors and the airstream.

The present teachings contemplate that more than one element may be disposed between the airstream and one or more thermal effectors. In which case, Eq. J and Eq. K may be performed as between each element in the system.

It may be appreciated that any thermal resistances, thermal capacitances, times to achieve the setpoint temperature, and the like may be unique to each element in the system (e.g., different materials have associated thermal resistances). These values may be pre-determined. These values may be stored in a memory storage medium, particularly a non-transient memory storage medium.

It may be appreciated that the identity of the “any other” heat transfer rate relative to the subject element in the system (e.g., \dot{Q}_{con}) may be unique to the subject element. For example, a heat exchanger thermally communicating with one or more thermal effectors may also thermally communicate with a conduit wall through which the heat exchanger may extend.

### Controlling Co-Located Thermal Effectors

One or more thermal effectors may affect a temperature change upon a surface and/or an airstream. Where multiple thermal effectors cooperate to affect a temperature change, they may be referred to herein as co-located thermal effectors. Multiple thermal effectors may contribute equally (e.g., provided equal or generally equal energies) to affect a temperature change. Multiple thermal effectors may function in a hierarchy (e.g., provided different energies). That is, each active thermal effector may contribute to progressively less and less heat transfer. Not all thermal effectors may function at any given time. The quantity of thermal effectors functioning at one time may depend on the magnitude of temperature change required. By way of example, a temperate change of 1° C. may only require the functioning of one thermal effector, whereas a temperature change of 10° C. may require the functioning of two or more thermal effectors.

Thermal effectors and/or thermal effector controllers may be in signal communication with one another to communicate their energy usage with one another. Thermal effectors and/or thermal effector controllers may be in signal communication with a dedicated system controller (location controller), an existing vehicle controller, or both. The dedicated system controller and/or the existing vehicle controller may function as a go-between for communicating energy usage between thermal effectors and/or thermal effector controllers.

The target heat transfer rate for a particular (individual) thermal effector (\dot{Q}_{eff-tgt(n)}) may be determined from the target total heat transfer rate required from all thermal effectors (\dot{Q}_{tot-eff}) and the heat transfer rate portioned to any other thermal effector (\dot{Q}ₒₜₕₑᵣ). The target temperature to be reached by the particular thermal effector (T_{eff-tgt}) may be determined from the target heat transfer rate for a particular (individual) thermal effector (\dot{Q}_{eff-tgt(n)}) and the thermal resistance between the effector and the medium (e.g., a material layer or a heat exchanger) it directly thermally communicates with (R_{eff-med}). Thus, the thermal effector may be regulated to achieve the target temperature to be reached by the particular thermal effector (T_{eff-tgt}). The target temperature to be reached by the particular thermal effector may be determined by the following equation.

$${T}_{eff - tgt} = ( {\dot{Q}}_{tot - eff} - {\dot{Q}}_{other} ) \times {R}_{eff - med} \qquad Eq . L$$

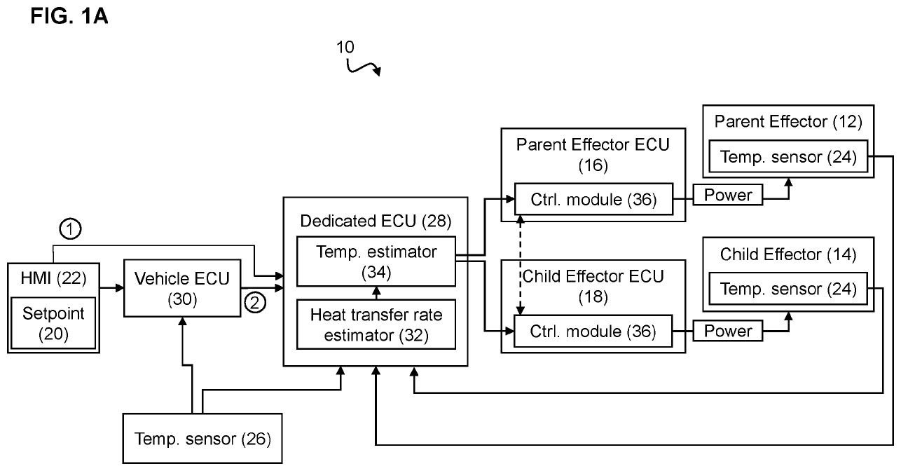

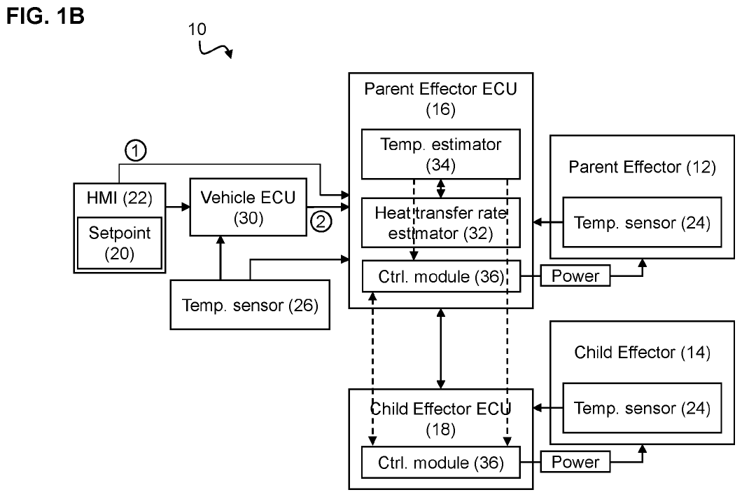

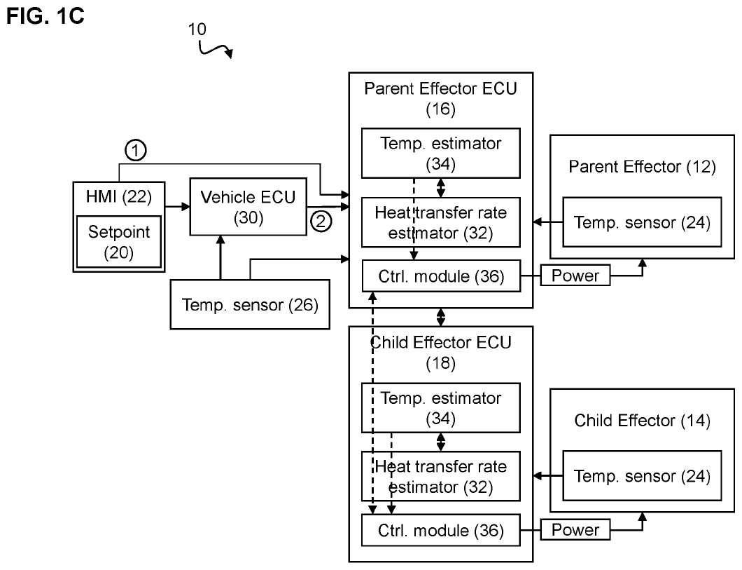

FIGS. 1A-1C illustrate a schematic of the system 10 according to the present disclosure. The system comprises a parent thermal effector 12 and a child thermal effector 14. The thermal effectors 12, 14 thermally influence a surface within a vehicle (e.g., a seat surface) and/or an airstream within a vehicle. The system 10 comprises a parent thermal effector electronic control unit 16 that controls the operation of the parent effector 12. The system 10 comprises a child thermal effector electronic control unit 18 that controls the operation of the child effector 14.

The present disclosure contemplates that the system comprises only one thermal effector. Thus, there is no parent/child configuration. The present disclosure contemplates that the system comprises a plurality of child thermal effectors. By way of example, a seat bottom, seat bottom bolsters (e.g., left and right bolsters), a seat back, seat back bolsters (e.g., left and right bolsters) of a vehicle seat may each be thermally influenced by a thermal effector where one thermal effector functions as a parent thermal effector and the other thermal effectors function as child thermal effectors. The same is applicable to electronic control units associated with each thermal effector.

The parent/child configuration may refer to one or more outputs (e.g., power usage) of the parent thermal effector that influence one or more outputs (e.g., power usage) provided to child thermal effectors. In this manner, the cooperation (e.g., power sharing) of co-located thermal effectors thermally influencing a surface and/or an airflow may be provided for. The parent/child configuration may refer to one or more calculations performed by the parent electronic control unit which produce one or more outputs employed by child effector electronic control units. In this manner, duplicative calculation efforts may be reduced or eliminated. The parent/child configuration may refer to one or more control signals provided by the parent electronic control unit that are employed by the child effector electronic control units. In this manner, the operation of child effectors may proceed in cooperation with the operation of a parent effector.

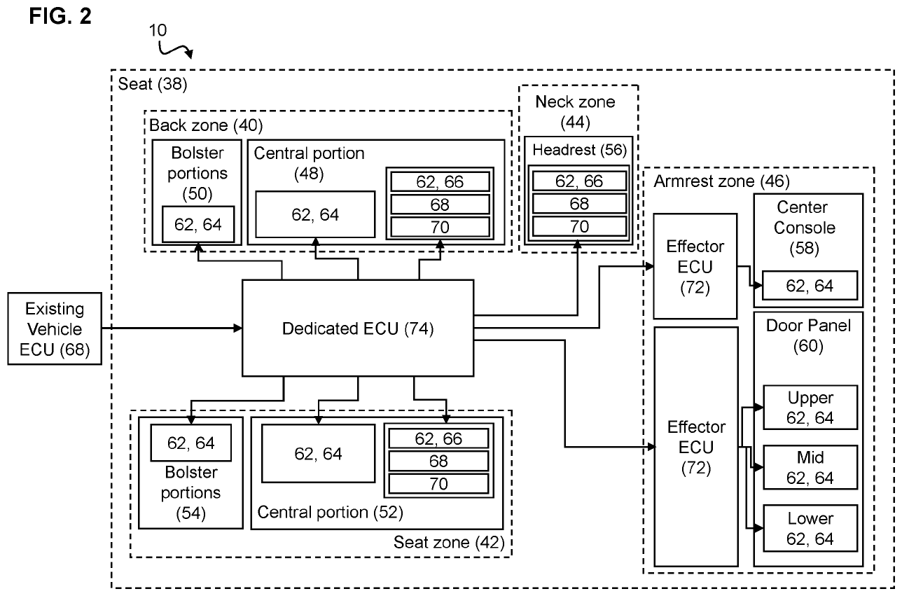

The system 10 controls the operation of the thermal effectors 12, 14. To do so, comparison of a setpoint 20 (e.g., temperature) to a current thermal condition (e.g., temperature of a surface or temperature of an airflow) determines the control signal and/or power required by the thermal effectors 12, 14 to achieve the setpoint 20. Moreover, such comparison may affect the control signal and/or power required by one or more blowers and/or one or more valves, illustrated in FIG. 2, to achieve the setpoint 20. To this end, the system 10 comprises a human-machine interface (HMI) 22 that receives inputs, from an occupant, associated with the setpoint 20 (e.g., temperature). The system 10 relies on dynamic estimations of current thermal conditions (e.g., temperature) of surfaces and/or airstreams located remote from the thermal effectors 12, 14. Heat transfer rates to and/or from a surface or an airstream may be calculated based on one or more sensed temperatures and/or assumed temperatures (e.g., assumed equal to the temperature of a cabin environment). The heat transfer rates may be employed to dynamically estimate the current thermal condition (e.g., temperature) of a surface and/or an airstream. The sensed temperatures may rely on sensors remote from the surface or the airstream. These sensors include temperature sensors 24 associated with the thermal effectors 12, 14 (e.g., a negative temperature coefficient (“NTC”) sensor), and temperature sensors 26 located anywhere else within the cabin of the vehicle. Thus, direct sensing of the current conditions of all thermally communicating elements and thus additional sensors in the vehicle are not required.

FIG. 1A shows a system according to the present teachings where a parent thermal effector electronic control unit 16, a child thermal effector electronic control unit 18, a dedicated system electronic control unit 28, and an existing vehicle electronic control unit 30 cooperate in operation. FIG. 1B and FIG. 1C show a system according to the present teachings where a parent thermal effector electronic control unit 16, a child thermal effector electronic control unit 18, and an existing vehicle electronic control unit 30 cooperate in operation. The system configurations illustrated are not limiting and any configuration that is practicable may be employed.

The setpoints 20 are ultimately communicated to a control module 36 (e.g., proportional integral derivative module) associated with the parent thermal effector electronic control unit 14 and the child thermal effector electronic control unit 18, in order to compare to the dynamically estimated surface and/or airstream temperature. The setpoints 20 may be communicated directly to the dedicated system electronic control unit 28 (see path 1 in FIG. 1A) or the parent thermal effector electronic control unit 16 (see path 1 in FIG. 1B and FIG. 1C). The setpoints 20 may be communicated to an existing vehicle electronic control unit 30 and then from the existing vehicle electronic control unit 30 to the dedicated system electronic control unit 28 (see path 2 in FIG. 1A) or the parent thermal effector electronic control unit 16 (see path 2 in FIG. 1B and FIG. 1C). The control module 36 functions to receive the dynamically estimated temperature of the surface and/or airstream, discussed below, compare the dynamically estimated temperature to the setpoint 20 provided by the HMI 22, and then provide a power output (e.g., PWM) to the respective thermal effectors 12, 14.

The parent thermal effector 12 and the child thermal effector 14 each comprise a temperature sensor 24. The temperature sensors 24 provide the sensed temperature of the thermal effectors 12, 14 as inputs to the dedicated system electronic control unit 28 (FIG. 1A) or the respective thermal effector electronic control units 16, 18 (FIG. 1B and FIG. 1C).

The dedicated system electronic control unit 28 comprises a heat transfer rate estimation module 32 (FIG. 1A), the parent thermal effector electronic control unit 16 comprises a heat transfer rate estimation module 32 (FIG. 1B), or the parent and child thermal effector electronic control units 16, 18 comprise a heat transfer rate estimation module 32 (FIG. 1C). As taught herein, heat transfer rates may be estimated based upon the temperatures of two thermally communicating mediums the surface area through which heat is transferred, and a thermal resistance

$$( \dot{Q} = \frac{( {T}_{2 -} {T}_{1} ) A}{R} ) .$$

The temperature provided by the temperature sensors 24 associated with the thermal effectors 12, 14 provide a temperature for use in the estimation. The temperature of any other thermal medium may be assumed equal to the temperature sensed by a local sensor (e.g., a sensor located within the cabin 26) or may be provided by an estimation from a prior program cycle. The estimation from the prior program cycle, surface area, and thermal resistance may be retrieved from a memory storage medium (e.g., local to the thermal effector control units 16, 18 and/or the dedicated system electronic control unit 28). One or more dynamically estimated temperatures may be obtained from the temperature estimator module 34 discussed below.

The dedicated system electronic control unit 28 comprises a temperature estimator module 34 (FIG. 1A), the parent thermal effector electronic control unit 16 comprises a temperature estimator module 34 (FIG. 1B), or the parent and child thermal effector electronic control units 16, 18 comprise a temperature estimator module 34 (FIG. 1C). As taught herein, temperature may be estimated based upon an initial temperature or a prior temperature of an element, one or more heat transfer rates relative to the element, a thermal capacitance, and a cycle time

$$( {T}_{est} = {T}_{n - 1} + \frac{\sum \dot{Q}}{C} \times t ) .$$

The initial temperature may be assumed equal to a temperature sensed by a local sensor (e.g., a sensor located within the cabin 26). The prior temperature may be provided by an estimation from a prior program cycle. The estimation from the prior program cycle and/or the thermal capacitance may be retrieved from a memory storage medium (e.g., local to the thermal effector control units 16, 18 and/or the dedicated system electronic control unit 28). The cycle time may be retrieved from a memory storage medium (e.g., local to the thermal effector control units 16, 18 and/or the dedicated system electronic control unit 28) or provided by a timer. One or more heat transfer rates may be obtained from the heat transfer rate estimation module 32, discussed above.

The parent thermal effector electronic control unit 14 and the child thermal effector electronic control unit 18 comprise a control module 36 (e.g., proportional integral derivative module) (FIGS. 1A-1B). The control module 36 functions to receive the dynamically estimated temperature of the surface and/or airstream, compare the dynamically estimated temperature to a setpoint temperature provided by the HMI 22, and then provide a power output (e.g., PWM) to the respective effectors 12, 14. The temperature estimator module 34 communicates with the control module 36 to provide the dynamically estimated temperature of the surface or airstream.

The system may comprise one or more child thermal effectors 14 that do include their own temperature estimator modules 34 (FIG. 1B). In this manner, duplicative calculations need not be performed. In this configuration, the temperature estimator module 34 associated with the parent thermal effector 12 may communicate the dynamically estimated temperature to the control module 36 associated with the child thermal effector 14.

The system may comprise multiple co-located thermal effectors that cooperate to condition a common surface, airflow, and/or vehicle component. In this case, power consumption may be equally or unequally distributed between the parent thermal effector 12 and the child thermal effector 14. Thus, the control modules 36 thereof may communicate their respective power usages to each other.

FIG. 2 illustrates a schematic of the system 10 according to the present disclosure. The system 10 operates to condition a seat 38 including a back zone 40 upon which an occupant's back rests, a seat zone 42 upon which an occupant's rear rests, a neck zone 44 located proximate to a seated occupant's neck, and an armrest zone 46 upon which an occupant's arms rest. The back zone 40 includes a central portion 48 and bolster portions 50. The seat zone 42 includes a central portion 52 and bolster portions 54. The neck zone 44 includes a headrest 56. The armrest zone 46 includes a center console portion 58 and a door panel portion 60.

Each of the portions of the zones comprise one or more thermal effectors 62.

The central portion 48 of the back zone 40 includes a resistance heater 64 and a thermoelectric device 66. The thermoelectric device 66 operates to condition an airstream that is delivered to a containment device, where the containment device conductively thermally communicates with the central portion 48. In cooperation with the thermoelectric device 66, a blower 68 generates the airstream that is conditioned, and one or more valves 70 direct the airstream into one or more conduits and/or mix the airstream with one or more other airstreams. The present disclosure contemplates that either or both of the resistance heater 64 and the thermoelectric device 66 (including the associated blower 68 and one or more valves 70) are present in the central portion 48. The bolster portions 50 of the back zone 40 include a resistance heater 64.

The central portion 52 of the seat zone 42 includes a resistance heater 64 and a thermoelectric device 66. The thermoelectric device 66 operates to condition an airstream that is delivered to a containment device, where the containment device conductively thermally communicates with the central portion 52. In cooperation with the thermoelectric device 66, a blower 68 generates the airstream that is conditioned, and one or more valves 70 direct the airstream into one or more conduits and/or mix the airstream with one or more other airstreams. The present disclosure contemplates that either or both of the resistance heater 64 and the thermoelectric device 66 (including the associated blower 68 and one or more valves 70) are present in the central portion 52. The bolster portions 54 of the seat zone 42 include a resistance heater 64.

The headrest 56 of the neck zone 44 includes a thermoelectric device 66. The thermoelectric device 66 operates to condition an airstream that is expelled from the headrest 56. In cooperation with the thermoelectric device 66, a blower 68 generates the airstream that is conditioned, and one or more valves 70 direct the airstream into one or more conduits and/or mix the airstream with one or more other airstreams.

The center console portion 58 of the armrest zone 46 includes a resistance heater 64.

The door panel portion 60 of the armrest zone 46 includes resistance heaters 64 in the upper, middle, and central portions thereof.

The thermal effector 62 (resistance heater 64) of the center console portion 58 is controlled by a thermal effector electronic control unit 72 associated with the center console portion 58. The thermal effectors 62 (resistance heaters 64) of the door panel portion 60 are controlled by a thermal effector electronic control unit 72 associated with the door panel portion 60. The present disclosure contemplates that the thermal effectors 62 of the center console portion 58 and the door panel portion 60 can be controlled by a dedicated system electronic control unit and/or the thermal effector electronic control units 72 may be eliminated.

The thermal effectors 62, the blowers 68, and the valves 70 of the back zone 40, the seat zone 42, and the neck zone 44 are controlled by a dedicated system electronic control unit 74. The present disclosure contemplates that one or more of the zones and/or the portions thereof may be controlled by a thermal effector electronic control unit local to and/or dedicated to that zone.

The dedicated system electronic control unit 74 may function as a parent controller and the thermal effector electronic control units 72 may function as child controllers. The present disclosure contemplates that any electronic control unit may function as a parent controller while any remaining electronic control units may function as child controllers.

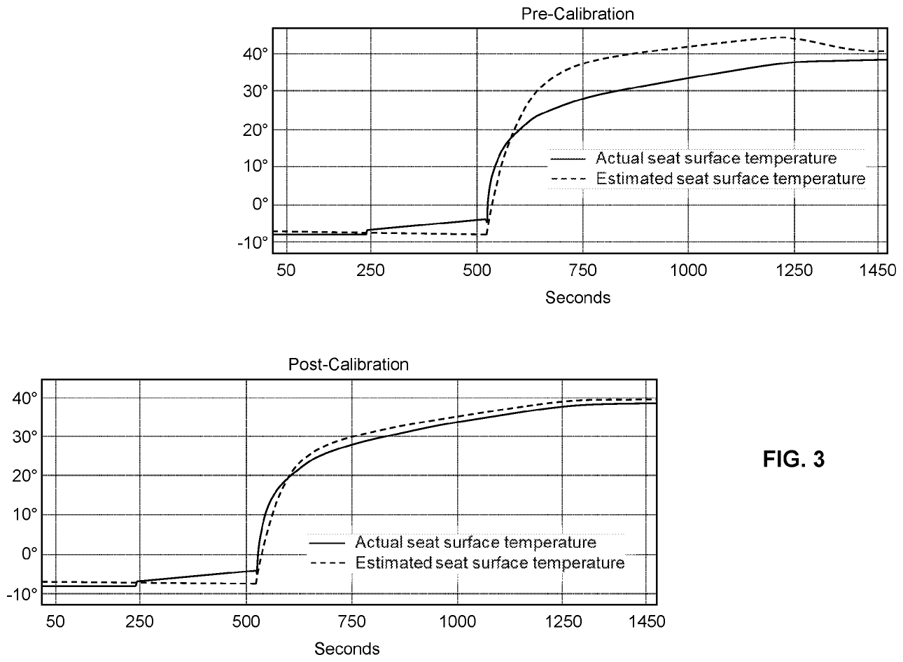

FIG. 3 illustrates graphs comparing the dynamically estimated surface temperature according to the present disclosure with the actual, measured surface temperature. Time (seconds) is presented on the X-axis while temperature (° C.) is presented on the Y-axis. Tolerance of the actual, measured temperature is illustrated with the shaded area. The surface was heated by a resistance heater. The surface was soaked at −10° C. and the temperature was ramped-up therefrom. Prior to calibration, the dynamic estimation varies outside of the tolerance zone of the actual, measured temperature. After calibration, the dynamic estimation substantially fits within the tolerance zone of the actual, measured temperature. That is, the dynamic estimation deviates at most about 1° C. from the tolerance zone only between the 400 and 500 second time frame.

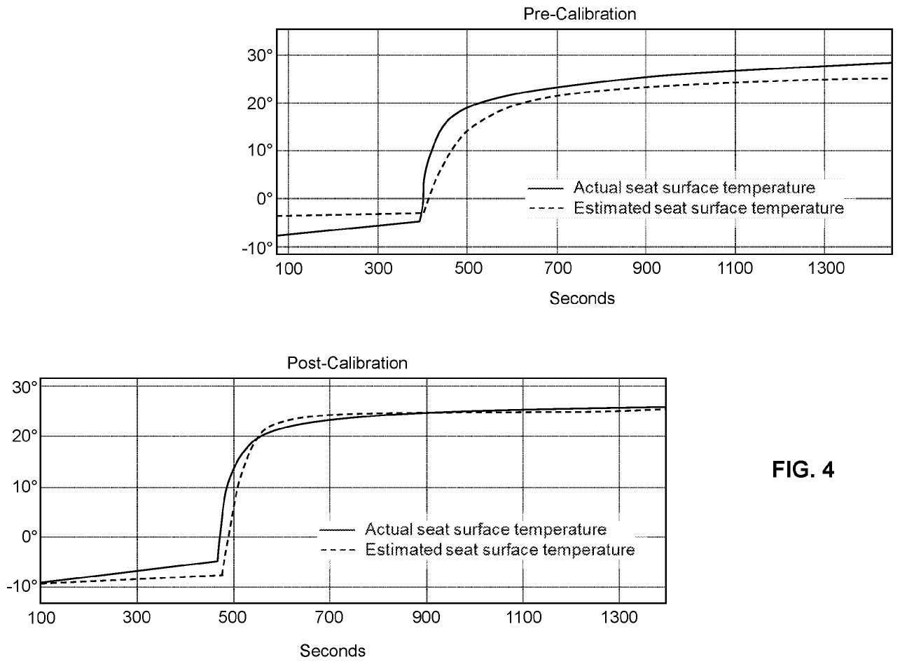

FIG. 4 illustrates graphs comparing the dynamically estimated surface temperature according to the present disclosure with the actual, measured surface temperature. Time (seconds) is presented on the X-axis while temperature (° C.) is presented on the Y-axis. Tolerance of the actual, measured temperature is illustrated with the shaded area. The surface was heated by a cooperating convective and conductive configuration. That is, an airflow conditioned by a thermal effector and delivered to a containment device that conductively thermally communicates with a vehicle component. The surface was soaked at −10° C. and temperature was ramped-up therefrom. Prior to calibration, the dynamic estimation varies outside of the tolerance zone of the actual, measured temperature. After calibration, the dynamic estimation substantially fits within the tolerance zone. That is, the dynamic estimation deviates at most about 1° C. from the tolerance zone only between the 300 and 500 second time frame.

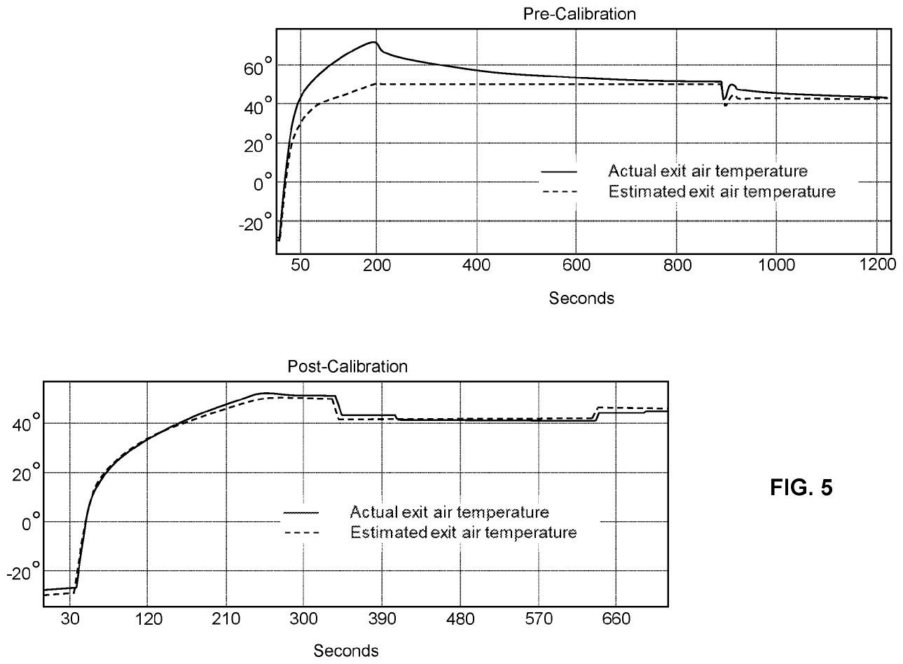

FIG. 5 illustrates graphs comparing the dynamically estimated airstream temperature, at an outlet, according to the present disclosure with the actual, measured airstream temperature. Time (seconds) is presented on the X-axis while temperature (° C.) is presented on the Y-axis. Tolerance of the actual, measured temperature is illustrated with the shaded area. The airstream was generated by a blower and heated by a resistance heater. The air source was soaked at −30° C. and temperature was ramped-up therefrom. Prior to calibration, the dynamic estimation varies outside of the tolerance zone. After calibration, the dynamic estimation fits within the tolerance zone.

Regarding the calibrations referenced in FIGS. 3-5, one or more parameters (e.g., thermal resistance, thermal capacitance, surface area, the like, or any combination thereof) employed in the dynamic temperature estimation and/or the heat transfer rate determination may be adjusted. That is, the adjusted parameter may not reflect its true value. Moreover, constants may be employed in the dynamic temperature estimation and/or the heat transfer rate determination to calibrate the system.

It is understood that the above description is intended to be illustrative and not restrictive. The explanations and illustrations presented herein are intended to acquaint others skilled in the art with the invention, its principles, and its practical application.

Those skilled in the art may adapt and apply the invention in its numerous forms, as may be best suited to the requirements of a particular use. Many embodiments as well as many applications besides the examples provided herein will be apparent to those of skill in the art upon reading the above description.

Accordingly, the specific embodiments of the invention set forth herein are not intended as being exhaustive or limiting of the teachings. The scope of the invention should, therefore, be determined not with reference to the above description, but should instead be determined with reference to the appended claims, along with the full scope of equivalents to which such claims are entitled.

The omission in the following claims of any aspect of subject matter that is disclosed herein is not a disclaimer of such subject matter, nor should it be regarded that the inventors did not consider such subject matter to be part of the disclosed inventive subject matter.

The disclosures of all articles and references, including patent applications and publications, are incorporated by reference for all purposes.

Plural elements or steps can be provided by a single integrated element or step. Alternatively, a single element or step might be divided into separate plural elements or steps.

The disclosure of “a” or “one” to describe an element or step is not intended to foreclose additional elements or steps.

The use of “about” or “approximately” in connection with a range applies to both ends of the range. Thus, “about 20 to 30” is intended to cover “about 20 to about 30”, inclusive of at least the specified endpoints.

Unless otherwise stated, all ranges include both endpoints and all numbers between the endpoints in increments of one unit provided that there is a separation of at least 2 units between any lower endpoint and any higher endpoint. As an example, if it is stated that the amount of a component, a property, or a value of a process variable such as, e.g., temperature, pressure, time, and the like is, e.g., from 1 to 90, from 20 to 80, or from 30 to 70, it is intended that intermediate range values such as, e.g., 15 to 85, 22 to 68, 43 to 51, 30 to 32, etc., are within the teachings of this specification. Likewise, individual intermediate values are also within the present teachings.

For values which are less than one, one unit is considered to be 0.0001, 0.001, 0.01, or 0.1 as appropriate. These are only examples of what is specifically intended and all possible combinations of numerical values between the lowest endpoint and the highest endpoint enumerated are to be considered to be expressly stated in this application in a similar manner.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

While the terms first, second, third, etc., may be used herein to describe various elements, components, regions, layers, and/or sections, these elements, components, regions, layers, and/or sections should not be limited by these terms. These terms may be used to distinguish one element, component, region, layer, and/or section from another region, layer, and/or section. Terms such as “first,” “second,” and other numerical terms when used herein do not imply a sequence or order unless clearly indicated by the context. Thus, a first element, component, region, layer, and/or section discussed below could be termed a second element, component, region, layer, and/or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the drawings. Spatially relative terms may be intended to encompass different orientations of the device in use or operation in addition to the orientation depicted in the drawings. For example, if the device in the drawings is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terms “generally” or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater.

The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

The method may comprise one or more of the steps recited herein. Some of the steps may be duplicated, removed or eliminated, rearranged relative to other steps, combined into one or more steps, separated into two or more steps, or a combination thereof.

The flow charts described herein do not imply a fixed order to the steps, and embodiments of the present invention may be practiced in any order that is practicable, unless otherwise specified herein.

### REFERENCE NUMERALS

10 System; 12 Parent thermal effector (“parent effector”); 14 Child thermal effector (“child effector”); 16 Parent thermal effector electronic control unit (“parent ECU”); 18 Child thermal effector electronic control unit (“child ECU”); 20 Setpoint; 22 Human-machine interface (“HMI”); 24 Temperature sensor (associated with athermal effector); 26 Temperature sensor (located within the cabin); 28 Dedicated system electronic control unit (“dedicated ECU”); 30 Existing vehicle electronic control unit (“vehicle ECU”); 32 Heat transfer rate estimator module; 34 Temperature estimator module; 36 Control module (proportional integral derivative module); 38 Seat; 40 Back zone; 42 Seat zone; 44 Neck zone; 46 Armrest zone; 48 Central portion of back zone; 50 Bolster portions of a back zone; 52 Central portion of a seat zone; 54 Bolster portions of a seat zone; 56 Headrest; 58 Center console portion; 60 Door panel portion; 62 Thermal effector; 64 Resistance heater; 66 Thermoelectric device; 68 Blower; 70 Valve; 72 Thermal effector electronic control unit; 74 Dedicated system electronic control unit; 76 Existing vehicle electronic control unit.

1. A conditioning system operable in a vehicle, the conditioning system comprising:
a thermal effector,
a first local sensor associated with the thermal effector, and
a controller in signaling communication with the thermal effector and the first local sensor;
wherein the controller or an additional controller dynamically estimates a thermal condition remote from and at least partially influenced by the thermal effector based on a first temperature sensed by the first local sensor and a second temperature sensed by a second local sensor; and
wherein the controller controls the thermal effector based on the dynamically estimated thermal condition.

2. The conditioning system according to claim 1, wherein the controller is a thermal effector controller local to the thermal effector.

3. The conditioning system according to claim 2, comprising two or more of the thermal effector and two or more of the controller, each of the two or more controllers being local to each of the two or more thermal effectors; and wherein the two or more thermal effectors condition a common surface and/or a common airstream, or the two or more thermal effectors condition a common vehicle component.

4. The conditioning system according to claim 3, wherein the two or more controllers communicate a power consumption signal amongst each other, the power consumption signal being indicative of power consumed by the two or more thermal effectors; and wherein the two or more thermal effectors contribute equally to power consumption, or the two or more thermal effectors function in a hierarchy with each successive thermal effector contributing progressively less to power consumption.

5. The conditioning system according to claim 4, wherein each of the two or more controllers dynamically estimate the thermal condition.

6. The conditioning system according to claim 5, wherein one of the two or more controllers, functioning as a parent controller, dynamically estimates the thermal condition and provides the same to the remainder of the two or more controllers, functioning as child controllers.

7. The conditioning system according to claim 6, wherein communication between the two or more controllers is undertaken via a local interconnect network bus.

8. The conditioning system according to claim 7, wherein the additional controller is a dedicated system controller local to a vehicle component that is conditioned by the conditioning system.

9. The conditioning system according to claim 5, wherein the additional controller functions as a parent controller, dynamically estimates the thermal condition and provides the same to the controller, functioning as a child controller.

10. The conditioning system according to claim 9, wherein communication between the controller and the additional controller is undertaken via a local interconnect network bus.

11. The conditioning system according to claim 1, wherein the thermal condition includes a temperature of a surface, a temperature of an airstream, or both;
wherein the surface is on a seat cushion, a seat back, a headrest, a door panel, a center console, a steering wheel, a gear shifter, an instrument panel, a headliner, a floor, a leg panel, or any combination thereof; and
wherein the airstream emanates from a vent in or on a seat cushion, a seat back, a headrest, a door panel, a center console, a steering wheel, a gear shifter, an instrument panel, a headliner, a floor, a leg panel, or any combination thereof; optionally where the vent communicates with a containment device.

12. The conditioning system according to claim 11, wherein the thermal condition is the temperature of the surface, and the controller or the additional controller determines a first heat transfer rate with respect to the surface, the first heat transfer rate being directly or indirectly influenced by the thermal effector; wherein the first heat transfer rate is ultimately determined by an input from the first local sensor; and wherein the dynamically estimated thermal condition is based on the first heat transfer rate.

13. The conditioning system according to claim 12, wherein the controller or the additional controller determines a second heat transfer rate with respect to the surface, the second heat transfer rate being influenced by a cabin environment, and/or the controller determines a third heat transfer rate with respect to the surface, the third heat transfer rate being influenced by an occupant; wherein the second heat transfer rate is ultimately determined by an input indicative of a temperature of the cabin environment; wherein the third heat transfer rate is ultimately determined by an input indicative of a temperature of the occupant; and wherein the dynamically estimated thermal condition is based on the second and/or third heat transfer rate.

14. The conditioning system according to claim 1, wherein the thermal condition is the temperature of the airstream, and the controller or the additional controller determines a first heat transfer rate with respect to the airstream, the first heat transfer rate being directly or indirectly influenced by the thermal effector; wherein the first heat transfer rate is ultimately determined by an input from the first local sensor; and wherein the dynamically estimated thermal condition is based on the first heat transfer rate.

15. The conditioning system according to claim 14, wherein the controller or the additional controller determines a second heat transfer rate with respect to the airstream, the second heat transfer rate being influenced by a cabin environment; wherein the second heat transfer rate is ultimately determined by an input indicative of a temperature of the cabin environment; and wherein the dynamically estimated thermal condition is based on the second heat transfer rate.

16. The conditioning system according to claim 1, wherein the first local sensor is located on or proximate to the thermal effector.

17. The conditioning system according to claim 16, wherein the thermal effector is located in or on a vehicle component; wherein the vehicle component includes a seat cushion, a seat back, a headrest, a door panel, a center console, a steering wheel, a gear shifter, an instrument panel, a headliner, a floor, a leg panel, a conduit, or any combination thereof; and wherein the thermal effector includes a resistance element, a thermoelectric device, or both.

18. (canceled)

19. The conditioning system according to claim 20, wherein controlling the thermal effector includes regulating power to the thermal effector and/or reversing the polarity of the thermal effector to achieve setpoint temperature; wherein said control is based on the dynamically estimated thermal condition and the setpoint temperature.

20. The conditioning system according to claim 17, comprising a human-machine interface adapted to receive a setpoint temperature, a setpoint mass air flow, or both; and wherein the controller or the additional controller receives from an existing vehicle controller: a setpoint temperature, a setpoint mass air flow, a temperature senses by a second local sensor, a power budget, an occupancy status, an operation mode, or any combination thereof.

21. The conditioning system according to claim 20, wherein the conditioning system comprises a blower and/or a valve; wherein the controller cooperates in controlling a blower speed and/or a valve position to achieve setpoint mass air flow and/or setpoint temperature; and wherein said control is based on the temperature dynamically estimated by the controller or the additional controller.

22. (canceled)
